(19) United States
(12) Patent Application Publication
(10) Pub. No.: US 2015/0369248 A1
(43) Pub. Date: Dec. 24, 2015

(54) ROTOR STRUCTURE AND ELECTRIC FLUID PUMP

(71) Applicant: HITACHI AUTOMOTIVE SYSTEMS, LTD., Ibaraki (JP)

(72) Inventor: Kunito NOGUCHI, Isesaki-shi, Gunma (JP)

(73) Assignee: HITACHI AUTOMOTIVE SYSTEMS, LTD., Hitachinaka-shi, Ibaraki (JP)

(21) Appl. No.: 14/767,017

(22) PCT Filed: Mar. 6, 2014
(86) PCT No.: PCT/JP2014/055731

§ 371 Date: Aug. 11, 2015

(30) Foreign Application Priority Data
Mar. 15, 2013 (JP) 2013-052667

(51) Int. Cl. F04D 13/06; F01D 5/14; B29C 70/84; B29C 70/70; B29C 70/68

(52) U.S. Cl. CPC F04D 13/06; B29C 70/70; B29C 70/682; B29C 70/84; F01D 5/147; B29L 2031/08

(57) ABSTRACT

Provided are a rotor structure capable of suppressing an increase in the number of process steps and an electric structure using the rotor structure. A rotor assembly 1 includes: a rotor core 9 having a plurality of electromagnetic steel sheets laminated together; a magnet insertion portion 10 formed in the electromagnetic steel sheets except the electromagnetic steel sheet 91 located at one axial end of the rotor core 9; a magnet 11 inserted in the magnetic insertion portion 10 from a side of the other axial end of the rotor core 9; a resin holder 12 arranged on the other axial end of the rotor core 9 so as to restrict axial movement of the magnet 11; and a resin mold part 13 formed integral with the resin holder 12 so as to cover the rotor core 9.

### FIELD OF THE INVENTION

The present invention relates to a rotor structure and to an electric fluid pump.

### BACKGROUND ART

Patent Document 1 discloses a laminated body of electromagnetic steel sheets having magnet insertion holes for insertion of magnets, wherein electromagnetic steel sheets with no magnet insertion holes are arranged at both axial ends of the laminated electromagnetic steel sheet body so as to prevent fall-off of the magnets from the magnet insertion holes.

### PRIOR ART DOCUMENTS

### Patent Documents

Patent Document 1: Japanese Laid-Open Patent Publication No. 2012-115016

### SUMMARY OF THE INVENTION

### Problem to Be Solved by the Invention

The above-disclosed conventional technique faces the problem that, in the case where the laminated electromagnetic steel sheet body is covered by a resin layer for the purpose of rust and corrosion protection, the resin layer cannot be formed on a portion of the laminated electromagnetic steel body supported by a jig during insert molding. This makes it necessary to perform another step of covering such a portion by the resin layer and thereby leads to an increase in the number of process steps.

It is accordingly an object of the present invention to provide a rotor structure capable of suppressing an increase in the number of process steps and to provide an electric fluid pump using the rotor structure.

### Means for Solving the Problem

In order to achieve the above object, the present invention provides a rotor structure including: a rotor core having, at one axial end thereof, an electromagnetic steel sheet with no magnetic insertion portion; a resin holder arranged on the other axial end of the rotor core so as to restrict movement of a magnet; and a resin mold part formed integral with the resin holder so as to cover the rotor core.

### Effects of the Invention

It is possible in the present invention to cover the rotor core by a resin layer in a single insert molding step and thereby suppress an increase in the number of process steps.

### BRIEF DESCRIPTION OF DRAWINGS

FIG. 1 is a top perspective view of a rotor assembly according to a first embodiment of the present invention.

FIG. 2 is a fragmentary cross-sectional view of an electric water pump equipped with the rotor assembly according to the first embodiment of the present invention.

FIG. 3 is a bottom view of a rotor core of the rotor assembly before insert molding according to the first embodiment of the present invention.

FIG. 4 is a bottom perspective view showing a procedure for assembling the rotor according to the first embodiment of the present invention.

FIG. 5 is a top perspective view of the rotor core of the rotor assembly before the insert molding according to the first embodiment of the present invention.

FIG. 6 is a bottom view of a rotor core of a rotor assembly before insert molding according to a second embodiment of the present invention.

FIG. 7 is a fragmentary cross-sectional view of an electric water pump with a rotor assembly according to a third embodiment of the present invention.

### DESCRIPTION OF EMBODIMENTS

### First Embodiment

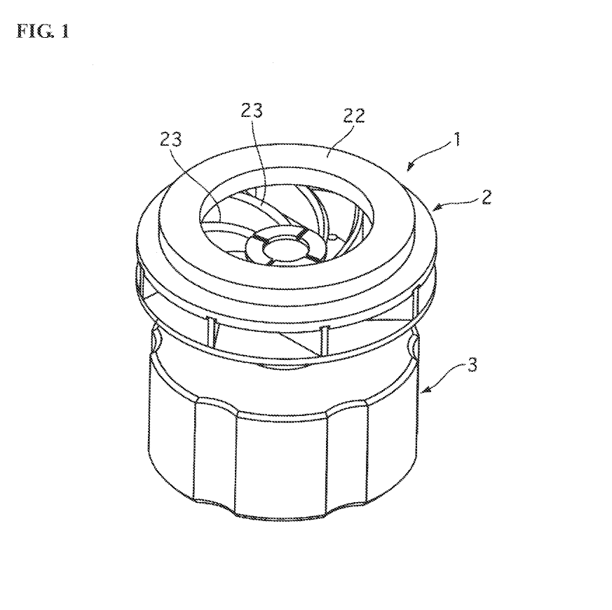

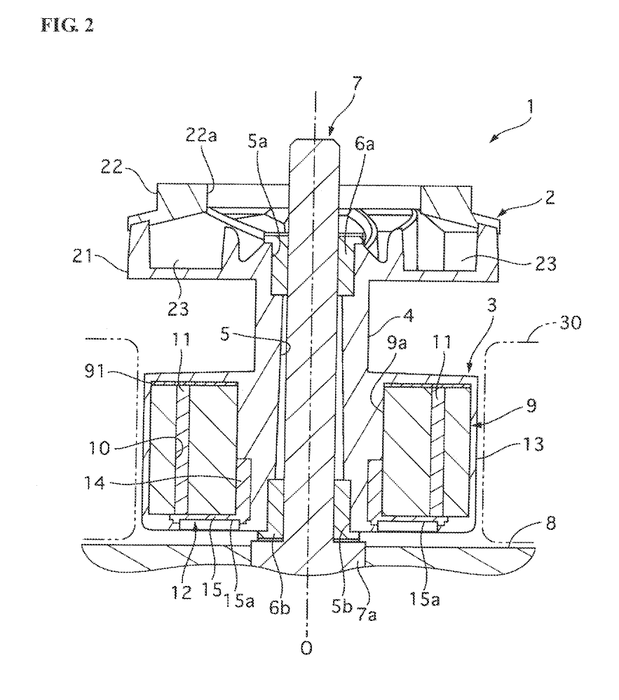

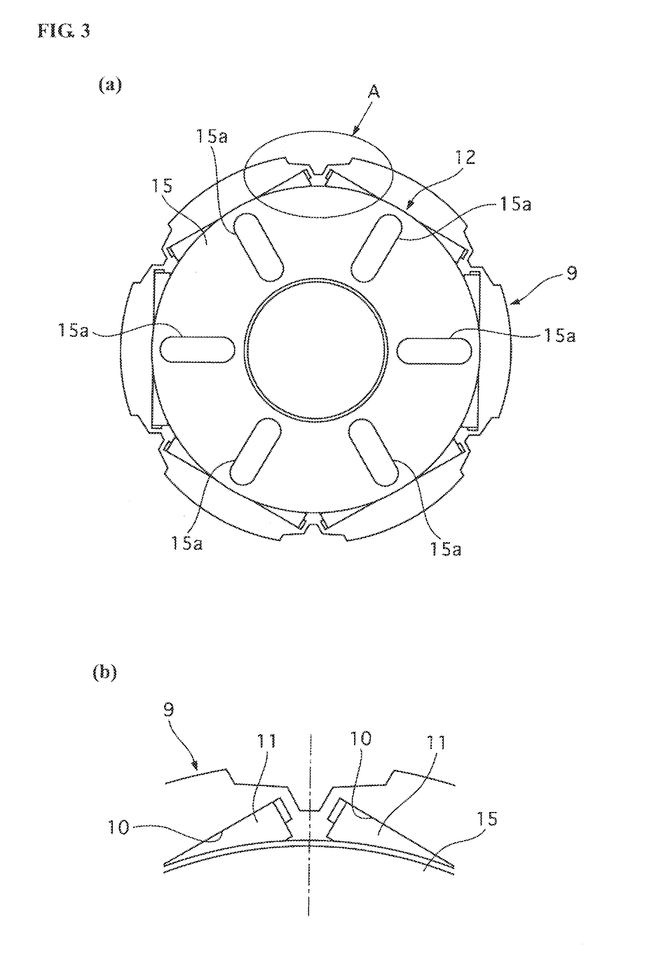

FIG. 1 is a top perspective view of a rotor assembly according to a first embodiment of the present invention. FIG. 2 is a fragmentary cross-sectional view of an electric water pump equipped with the rotor assembly according to the first embodiment of the present invention. FIG. 3 is a bottom view of a rotor core of the rotor assembly before insert molding according to the first embodiment of the present invention.

In the first embodiment, the rotor assembly 1 is adapted for use in the electric water pump as a source for supply of engine cooling water. The rotor assembly 1 generally includes an impeller 2 and a rotor 3 assembled together with a synthetic resin. The impeller 2 and the rotor 3 are connected to each other by a small-diameter part 4 which is smaller in diameter than the outer diameters of the impeller 2 and the rotor 3. A through hole 5 is formed through the center of the rotor assembly 1. Bearing accommodation portions 5a and 5b are formed in both ends of the through hole 5. Bearings 6a and 6b are press-fitted in the bearing accommodation portions 5a and 5b, respectively. A shaft 7 is inserted through the through hole 5 such that the rotor assembly 1 is rotatably supported on the shaft 7 via the bearings 6a and 6b. The shaft 7 is generally circular rod-shaped and has a large-diameter portion 7 formed on one axial end thereof and fixed to a pump housing 8 in which the impeller 2 and the rotor 3 are installed. Further, a stator 30 is fixed to a side of the pump housing 8 facing the rotor 3. A coil (not shown) of the stator 3 is energized in accordance with the rotation control of the rotor 3.

The impeller 2 includes a hub 21, a shroud 22 and a plurality of (e.g. eight) blades 23.

The hub 21 is formed into a disk shape integral with the rotor 3 and is rotated and driven about a center axis of the rotor 3 (which is substantially in agreement with a center axis of the shaft 7 and hereinafter referred to as “center axis O”). The hub 21 is oriented perpendicular to the direction of the center axis.

The shroud 22 is arranged on a side of the hub 21 opposite from the rotor 3 in the direction of the center axis O such that the hub 21 and the shroud 22 face each other. The shroud 22 is substantially disk-shaped. A circular opening 22a is formed through the center of the shroud 22 for fluid suction.

The blades 23 are formed integral with the hub 21 and disposed circumferentially at predetermined equal intervals. Each of the blades 23 extends radially outwardly from the center such that the blades 23 are in a radial spiral arrangement when viewed in plan. Inner ends of the respective blades 23 are located on a circle smaller in diameter than the opening diameter of the opening 22a.

The rotor 3 includes a rotor core 9, magnet insertion portions 10, magnets 11, a resin holder 12 and a resin mold part 13.

The rotor core 9 has a plurality of electromagnetic steel sheets cut out in a predetermined shape from a sheet material by press working and laminated together in the direction of the center axis O. The rotor core 9 is substantially donut-shaped. An opening 9a is formed through the center of the rotor core 9.

The magnet insertion portions 10 are formed through all of the electromagnetic steel sheets, except one electromagnetic steel sheet 91 located at one axial end of the rotor core 9, so as to define holes for insertion and accommodation of the magnets 11. It is herein noted that all of the electromagnetic steel sheets except the electromagnetic steel sheet 91 are simplified in FIG. 2. In the first embodiment, six magnet insertion portions 10 are disposed circumferentially at equal intervals. Each of the magnet insertion portions 10 is substantially rectangular in shape and made slightly larger than the outer diameter of the magnet 11. The magnet insertion portions 10 are formed during press working of the electromagnetic steel sheets.

The magnets 11 are formed as rectangular cross-section permanent magnets. The magnets 11 are magnetized after inert molding of the hub 21, the blades 23, the small-diameter part 4 and the resin mold part 13.

The resin holder 12 is arranged on the other axial end of the rotor core 9 so as to restrict axial movement of the magnets 11 in the magnet insertion portions 10. The resin holder 12 is formed of the same synthetic resin as that of the resin mold part 13 and has a cylindrical portion 14 and a flanged portion 15. The cylindrical portion 14 is circular cylindrical-shaped and inserted in the opening 9a of the rotor core 9. The flanged portion 15 is substantially donut-shaped and disposed on the other axial end side of the cylindrical portion 14. Substantially elongated hole-shaped grooves 15a are formed in the other axial end side of the flanged portion 15a. In the first embodiment, six grooves 15a are arranged circumferentially at equal intervals as also shown in FIG. 3(a). These grooves 15a are used for engagement with lugs of a supporting jig during insert molding.

As shown in FIG. 3(b), which is an enlarged view of region A of FIG. 3(a), the outer diameter of the flanged portion 15 is set to such a value that the magnet insertion portions 10 and the magnets 11 are partially exposed without the magnet insertion portions 10 being completely covered by the flanged portion 15.

The resin mold part 13 is formed as a resin layer so as to cover the whole of the rotor core 9, except the grooves 15a of the resin holder 12, for the purpose of protecting the rotor core 9 from rust and corrosion. The resin mold part 13 is resin molded simultaneously with the hub 21, the blades 23 and the small-diameter part 4.

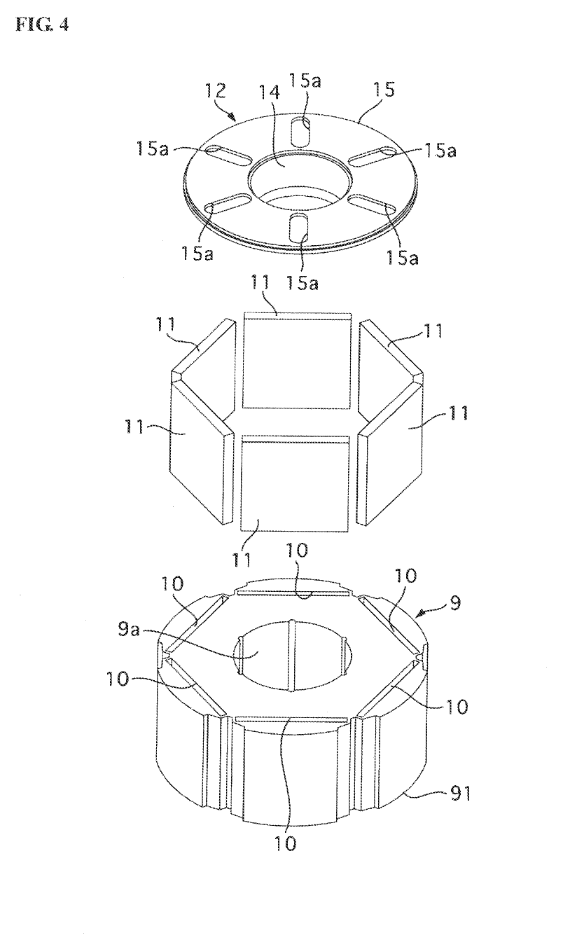

FIG. 4 is a bottom perspective view showing the assembling procedure of the rotor.

First, the press step is performed as follows. The electromagnetic steel sheets are cut out by press working. The electromagnetic steel sheet 91 with no magnet insertion portion 10 is placed on the bottom side. The plurality of the electromagnetic steel sheets with the magnetic insertion portions 10 are laminated on the electrometric steel sheet 91 by so-called dowel caulking, thereby constituting the rotor core 9. It is herein noted that the dowel caulking is a caulking technique to form protrusions called dowels at predetermined positions on the electromagnetic steel sheets and join the electromagnetic steel sheets by engagement of the protrusions of the electromagnetic steel sheets into depressions behind the protrusions of the adjacent electromagnetic steel sheets.

Next, the magnets 11 are inserted into the magnet insertion portions 10 from the top side. The resin holder 12 is then attached to the top side of the rotor core.

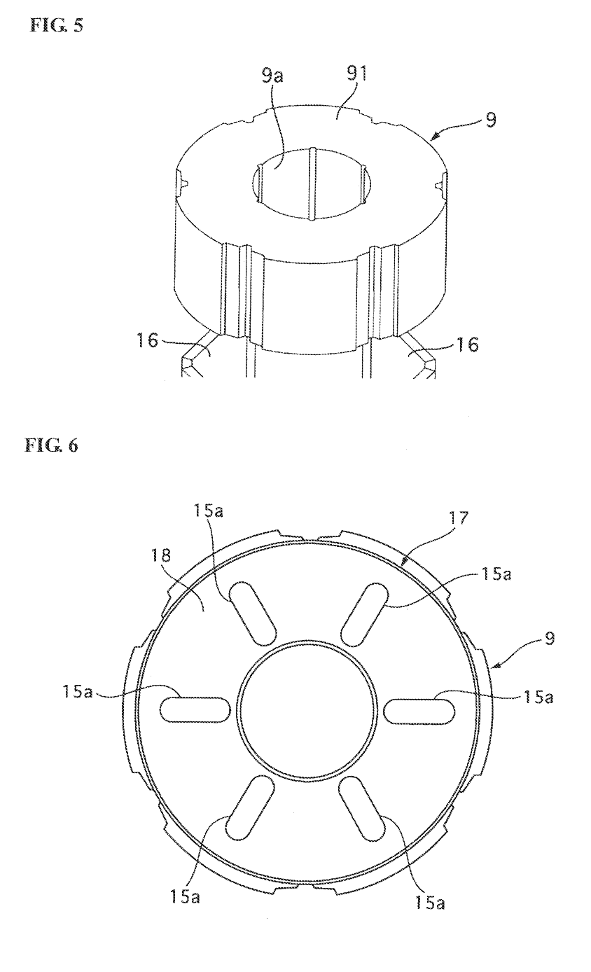

After the above rotor assembling, the insert molding step is performed. In the insert molding step, the hub 21, the blades 23, the small-diameter part 4 and the resin mold part 13 are insert-molded by the use of a mold with engagement of the lugs 16 of the supporting jig in the respective grooves 15a as shown in FIG. 5. As the magnet insertion portions 10 are partially exposed, the resin flows into the magnetic insertion portions 10 so that the magnets 11 are fixed by the resin in the magnetic insertion portions 10.

Subsequently, the shroud 22 and the blades 23 are welded to the hub. Further, the magnets 11 are magnetized.

By this, the rotor assembly 1 is completed as shown in FIGS. 1 and 2.

The features and operations of the first embodiment will be explained below.

In the conventional rotor structure, the electromagnetic steel sheets with no magnet insertion portions are arranged at both ends of the rotor core so as to prevent fall-off of the magnets. During the insert molding step, the resin layer cannot be formed on the portion of the rotor core supported by the jig. It is thus necessary to perform another step of covering such a portion by the resin layer. This leads to an increase in the number of process steps.

In addition, the assembling of the rotor is done by placing the electric steel sheet with no magnet insertion portion on the bottom side, laminating the plurality of the electromagnetic steel sheets with the magnetic insertion portions on the bottom-side electrometric steel sheet, inserting the magnets into the magnet insertion portions, fixing the magnets by introduction of an adhesive into the magnet insertion portions, and then, fixing the electric steel sheet with no magnet insertion portion on the top side. It is thus necessary to suspend the press step at the time of insertion of the magnets in the course of lamination of the electromagnet steel sheets. This leads to a deterioration in productivity. It is also necessary to insert the magnets in the magnet insertion portions and introduce the adhesive into the magnet insertion portions during the press step. This results in process fragmentation.

On the other hand, the first embodiment is characterized in that: the electromagnetic steel sheet 91 is arranged at one axial end of the rotor core 9 so as to cover the magnet insertion portions 10; the resin holder 12 is arranged on the other axial end of the rotor core 9 so as to restrict movement of the magnets 11; and the resin mold part 13 is formed integral with the resin holder 12 so as to cover the rotor core 9. The insert molding step can be performed while supporting the rotor core by fixing the grooves 15a of the resin holder 12 to the supporting jig. It is therefore possible to cover the rotor core 9 by the resin layer in a single insert molding step and thereby suppress an increase in the number of process steps.

Further, the shapes of the electromagnetic steel sheet 91 and the other electromagnetic steel sheets of the rotor core 9 are different in only the presence or absence of the magnet insertion portions 10. The press working and lamination can be performed in a continuous press process by skipping the formation of the magnet insertion portion 10 in the electromagnetic steel sheet 91. There is no necessity to insert the magnets 11 in the course of lamination. It is thus possible to attain an improvement in productivity.

It is also possible to attain process simplification as the fall-off of the magnets 11 can be prevented by attachment of the resin holder 12 after insertion of the magnets 11 into the magnet insertion portions 10.

Furthermore, the flanged portion 15 of the resin holder 12 is so shaped as not to completely cover the magnet insertion portions 15 so that the resin can be introduced into the magnet insertion portions 10 during the insert molding. It is thus possible to properly fix the magnets without the use of an adhesive and attain process simplification.

Namely, the first embodiment has the following effects.

(1) The rotor structure includes:
the rotor core 9 having the plurality of the electromagnetic steel sheets laminated together;
the magnet insertion portions 10 formed through all except one of the electromagnetic steel sheets located at one axial end of the rotor core 9;
the magnets 11 inserted in the magnet insertion portions 10 from a side of the other axial end of the rotor core 9;
the resin holder 12 arranged on the other axial end of the rotor core 9 so as to restrict axial movement of the magnets 11; and
the resin mold part 13 formed integral with the resin holder 12 so as to cover the rotor core 9.

In this configuration, the insert molding step can be performed while supporting the resin holder 12 by the supporting jig. It is therefore possible to cover the rotor core 9 by the resin layer in a single insert molding step and suppress an increase in the number of process steps.

(2) The flanged portion 15 of the resin holder 2 is so shaped as to partially cover the magnet insertion portions 11.

It is possible in this configuration to, while restricting axial movement of the magnets 11, fixing the magnets 11 by introduction of the resin into the magnet insertion portions 10 during the insert molding and suppress an increase in the number of process steps.

(3) In the electric water pump where the rotor 3 and the impeller 2 are integrated with each other by insert molding using the rotor core 9 in which the plurality of electromagnetic steel sheets are laminated as an insert, the rotor 3 has the above rotor structure (1), (2).

It is possible in this configuration to manufacture the electric water pump with high rust/corrosion resistance at low cost.

### Second Embodiment

A second embodiment of the present invention is different from the first embodiment in the outer diameter of the flanged portion of the resin holder.

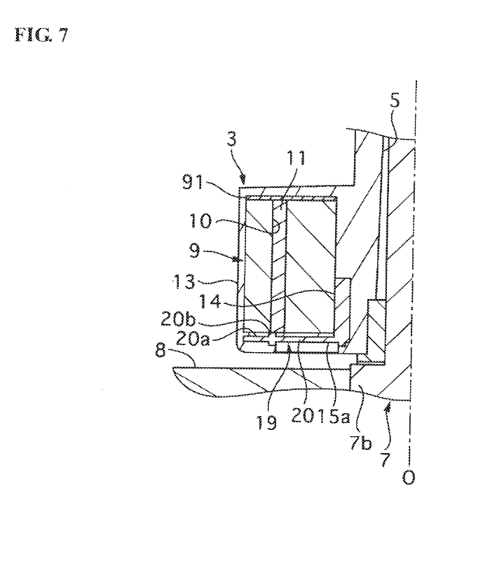

FIG. 6 is a bottom view of the rotor core of the rotor assembly before the insert molding according to the second embodiment of the present invention.

In the second embodiment, the outer diameter of the flanged portion 18 of the resin holder 17 is set to such a value that the flanged portion 18 completely cover the magnet insertion portions 10.

The other parts and portions of the second embodiment are the same as those of the first embodiment; and their detailed explanation and illustration will be omitted herefrom.

In the second embodiment, the flanged portion 18 completely covers the magnet insertion portions 10. It is thus possible in the third embodiment to increase the interface distance between the resin holder 17 and the resin mold part 13 and improve the interface bond strength between the resin holder 17 and the resin mold part 13 as compared to the first embodiment.

Namely, the second embodiment provides the following effect in addition to the above effects (1) and (3) of the first embodiment.

(4) The flanged portion 18 of the resin holder 17 is so shaped as to completely cover the magnet insertion portions 10.

It is possible in this configuration to increase the interface distance between the resin holder 17 and the resin mold part 13 and improve the interface bond strength between the resin holder 17 and the resin mold part 13.

### Third Embodiment

A third embodiment of the present invention is different from the second embodiment in the shape of the rotor core side of the flanged portion.

FIG. 7 is a fragmentary cross-sectional view of the electric water pump according to the third embodiment of the present invention.

In the third embodiment, protrusions 20b are formed on the rotor core side surface 20a of the flanged portion 20 of the resin holder 19 such that each of the protrusions 20b is circular in shape when viewed in plan. Herein, six protrusions 20b are disposed circumferentially at predetermined intervals so as to correspond in position to the magnet insertion portions 10 in the third embodiment. These protrusions 20b are brought into contact with the magnets 11 in the magnet insertion portions 10, thereby leaving clearance between the rotor core side surface 20a and the rotor core 9.

The other parts and portions of the third embodiment are the same as those of the second embodiment, and their detailed explanation and illustration will be omitted herefrom.

In the third embodiment, the protrusions 20b are formed on the rotor core side surface 20a of the flanged portion 20 so that the resin flows into the clearance between the rotor core side surface 20a and the rotor core 9 during the insert molding. It is thus possible in the third embodiment to increase the interface distance between the resin holder 19 and the resin mold part 13 and improve the interface bond strength between the resin holder 19 and the resin mold part 13 as compared to the first embodiment. It is also possible to attain process simplification as the magnets 11 can be fixed in the magnet insertion portions 11 by introduction of the resin into the magnet insertion portions 10 during the insert molding.

Namely, the third embodiment provides the following effect in addition to the above effects (1) and (3) of the first embodiment.

(5) The protrusions 20b are formed on the rotor core side surface 20a of the flanged portion 20.

It is possible in this configuration to increase the interface distance between the resin holder 19 and the resin mold part 13 and improve the interface bond strength between the resin holder 19 and the resin mold part 13. It is also possible to fix the magnets 11 by introduction of the resin into the magnet insertion portions 10 during the insert molding and attain process simplification.

### Other Embodiments

Although the present invention has been described in detail with reference to the above specific embodiments, the present invention is not limited to these specific embodiments. It is apparent to those skilled in the art that various changes and modifications can be made without departing from the technical idea of the present invention and fall within the scope of the present invention.

For example, the shape of the flanged portion of the resin holder is not limited to the circular shape. The flanged portion of the resin holder can alternatively be formed into any other shape such as polygonal shape as long as the resin holder, when attached to the rotor core, restricts axial movement of the magnets while allowing the magnets to be partially exposed.

Although the present invention is particularly suitably applied as the rotor structure of the electric fluid pump where high rust/corrosion resistance is required, it is feasible to apply the present invention as the rotor structure of the other electric fluid pump for process step increase suppression and for process simplification.

The uneven shape of the flanged portion is not particularly restricted as long as the resin can flow into the magnet insertion portions during the insertion molding. The uneven shape of the third embodiment may be applied to the flanged portion of the first embodiment.

1. A rotor structure, comprising:
a rotor core having a plurality of electromagnetic steel sheets laminated together;
a magnet insertion portion formed axially in the rotor core and being closed at one axial end of the rotor core;
a magnet inserted into the magnet insertion portion from a side of the other axial end of the rotor core;
a resin holder arranged on the other axial end of the rotor core so as to restrict movement of a magnet; and
a resin mold part formed integral with the resin holder, by molding while supporting the rotor core through the resin holder, so as to cover the whole of the rotor core.

2. An electric fluid pump, comprising:
a rotor;
an impeller integrated with the rotor; and
a stator located facing the rotor and having a coil,
the rotor comprising:
a rotor core having a plurality of electromagnetic steel sheets laminated together;
a magnet insertion portion formed axially in the rotor core and being closed at one axial end of the rotor core;
a magnet inserted in the magnet insertion portion from a side of the other axial end of the rotor core;
a resin holder arranged on the other axial end of the rotor core so as to restrict movement of a magnet; and
a resin mold part formed integral with the resin holder, by molding while supporting the rotor core through the resin holder; so as to cover the whole of the rotor core.

3. The rotor structure according to claim 1, wherein the resin holder partially covers the magnet insertion portion.

4. The electric fluid pump according to claim 2, wherein the resin holder partially covers the magnet insertion portion.

5. The rotor structure according to claim 1, wherein the resin holder completely covers the magnet insertion portion.

6. The electric fluid pump according to claim 2, wherein the resin holder completely covers the magnet insertion portions.

7. The rotor structure according to claim 1, wherein a rotor core side surface of the resin holder is formed into an uneven shape.

8. The electric fluid pump according to claim 2, wherein a rotor core side surface of the resin holder is formed into an uneven shape.

9. The rotor structure according to claim 3, wherein a rotor core side surface of the resin holder is formed into an uneven shape.
